(19) United States
(12) Patent Application Publication
(10) Pub. No.: US 2003/0032321 A1
(43) Pub. Date: Feb. 13, 2003

(54) Sealed connector

(75) Inventors: Darrell L. Wertz, York, PA (US); Navin K. Patel, Mechanicsburg, PA (US); Dennis J. Smith, Minneapolis, MN (US)

Correspondence Address: Tyco Technology Resources, Suite 450, 4550 New Linden Hill Road, Wilmington, DE, 19808-2952, US

(73) Assignee: Tyco Electronics Corporation, Middletown, PA

(21) Appl. No.: 09/929,603

(22) Filed: Aug. 13, 2001

(51) Int. Cl. H01R 13/52

(52) U.S. Cl. 439/282

(57) ABSTRACT

An electrical connector (12) includes an inner housing (14) having a terminal (30) disposed therein; and an elastomeric outer housing (50) disposed around the inner housing (14) and having at least one sealing member (56) that extends around a peripheral surface of the outer housing (50) and a retention member extending outwardly from the surface. Upon mating with the complementary connector (70), the outer housing (50) provides both the sealing of and retention for the mated connector assembly (10).

### FIELD OF THE INVENTION

The present invention is directed to electrical connectors and more particularly to sealed electrical connectors.

### BACKGROUND OF THE INVENTION

Sealed connectors and connector assemblies are often used when the connectors will be exposed to atmospheric conditions that include moisture or other possible contaminants. Typically these connectors include one or more O-rings that are spaced along the outer surface of the connectors and engage cooperating surfaces of the mating connectors. The assemblies generally include connector housings that are latchable together at the mating interface and have sealing members or potting compound disposed around the terminals where they are terminated to respective conductors. The latching members on the housings generally are on the exterior of the housings and require some space around the housing for a latch arm or similar feature to move into the latched position. In some applications, however, the additional space for external latching and/or room to permit insertion of a tool or fingers to release the latches is not available. In other instances access to the mating connector may be limited. It is desirable, therefore, to have a connector that provides retention as well as sealing without increasing the outer dimensions of the two connectors to accommodate latching. It is further desirable to have a connector that requires a minimum of components, thus reducing the time and steps needed to assemble the connector.

### SUMMARY OF THE INVENTION

The present invention is directed to a sealed connector that overcomes problems associated with the prior art. For purposes of illustration the connector is shown as a circular cable connector. It is to be understood that the invention is not limited to this design. The connector includes an inner housing having at least one terminal disposed therein, and an elastomeric outer housing disposed around the inner housing and having at least one sealing member that extends outwardly around the peripheral surface of the outer housing and is dimensioned to be sealingly received within a connector receiving cavity of a complementary connector upon being mated thereto and at least one retention member that extends outwardly from the peripheral surface of the outer housing and is dimensioned to cooperate with a complementary surface within the cavity to retain the mated connectors together. Upon mating the connector with the complementary connector, the outer housing provides both sealing and retention for the mated connector assembly.

In one representative embodiment of the invention a single protrusion extends around the peripheral surface defining both the sealing member and the retention member. In another representative embodiment, the sealing member and the retention member are spaced from each other.

Additionally, when the at least one terminal is terminated to a conductor of a cable, the outer housing is formed around a portion of the cable, thus functioning as a strain relief for the cable.

It is an object of the invention to provide a connector that requires a minimum number of parts, is cost effective to manufacture and provides an effective seal with a mating connector.

Embodiments of the invention will now be described by way of example with reference to the accompanying drawings.

### BRIEF DESCRIPTION OF THE DRAWINGS

FIG. 1 is an isometric view of one embodiment of a connector made in accordance with the invention.

FIG. 2 is an isometric view of a complementary connector that is matable with the connector of FIG. 1.

FIG. 3 is a cross-sectional view the connector of FIG. 1 partially mated with the complimentary connector of FIG. 2.

FIG. 4 is a cross-sectional view the connector of FIG. 1 fully mated with the complimentary connector of FIG. 2.

FIG. 5 is another cross-sectional view similar to that of FIGS. 3 and 4 illustrating the air release passageway.

FIG. 6 is an isometric view of another embodiment of a connector made in accordance with the invention.

FIG. 7 is a cross-sectional view the connector of FIG. 6 partially mated with the complimentary connector of FIG. 2.

FIG. 8 is a cross-sectional view the connector of FIG. 6 fully mated with the complimentary connector of FIG. 2.

### DETAILED DESCRIPTION OF EMBODIMENTS OF THE INVENTION

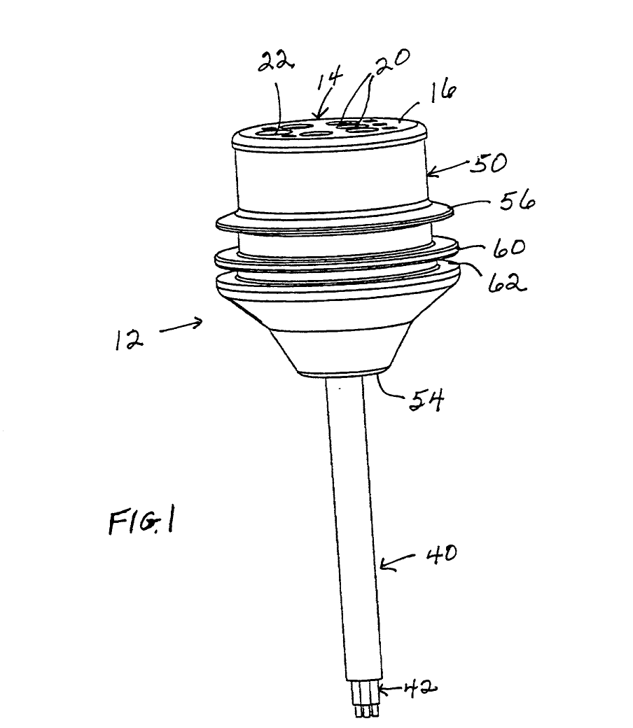

Referring first to FIGS. 1 through 5, connector assembly 10 includes connector 12 and complimentary connector 70 that are configured to form a sealed interface upon being mated to one another. For purposes of illustrating the invention, connector 12 is shown as a circular connector. Connector 70 may be an individual connector or a connector secured to an apparatus or device, such as, for example, a bulkhead or the like. Connector 12 includes an inner housing 14, a plurality of terminals 30, and an outer or overmolded housing 50. Inner housing 14 has a mating face 16, an assembly face 18, and a plurality of terminal receiving passageways 20 extending therebetween. Inner housing 14 includes a plurality of recesses 24 extending around the circumference. In the embodiment shown, inner housing 14 further includes an aperture 22 extending partially into the housing that is used for aligning connector 12 to a complementary connector 70, as more fully explained below. For purposes of illustration terminal 30 is shown as a socket terminal having first and second connecting portions 32, 34. Second connecting portion 34 is terminated to a conductor 42 of cable 40 proximate assembly face 18.

The outer housing 50 is overmolded from elastomeric material around inner housing 14 after the terminals 30 have been terminated to respective conductors 42. Outer housing 50 includes a forward end 52 and a rearward end 54 that is molded around cable 40 providing a strain relief for cable 40. The peripheral surface of outer housing 50 includes a protrusion or rib 56 thereabout that, in this embodiment, defines both a sealing member and a retention member. As shown in these Figures, a flange 60 is formed around the housing 50 rearward of protrusion 56 and forwardly of rearward end 54, defining a notch 62. A tool such as a screwdriver or the like can be inserted into notch 62 to aid in the unmating of connector 12 from connector 70.

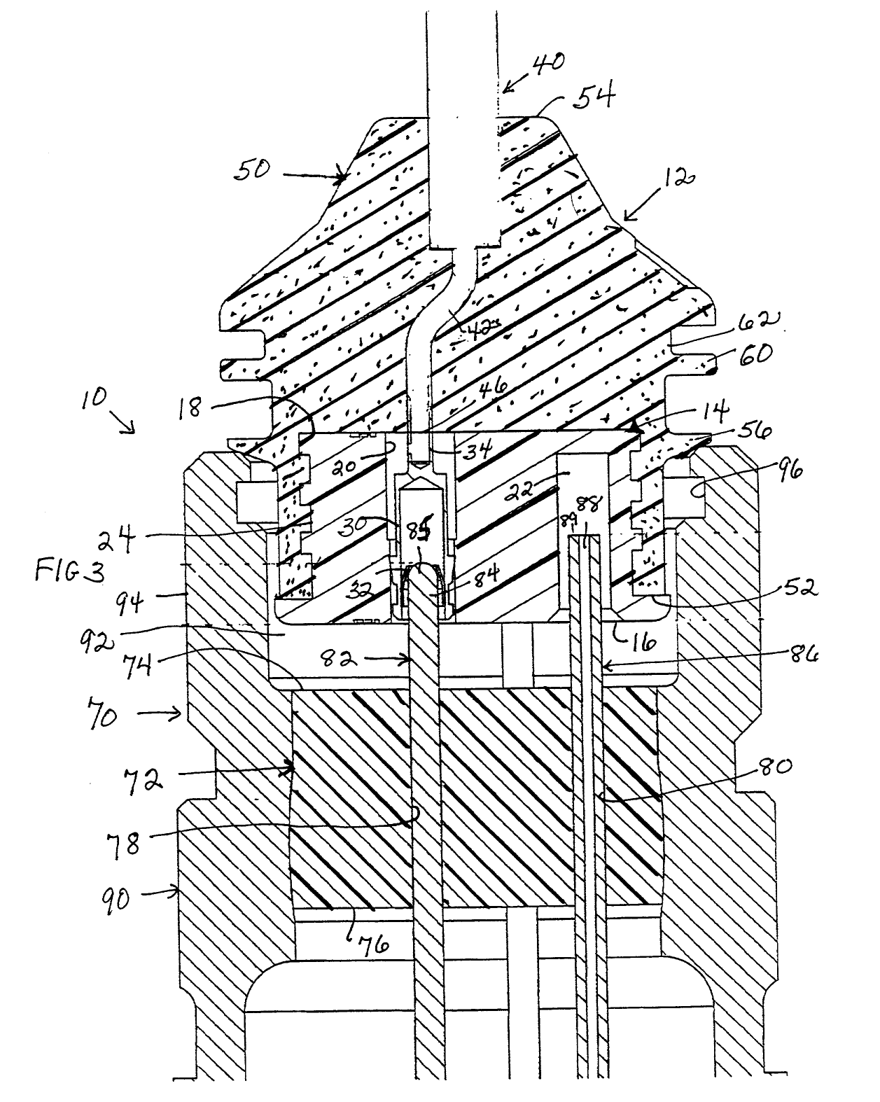

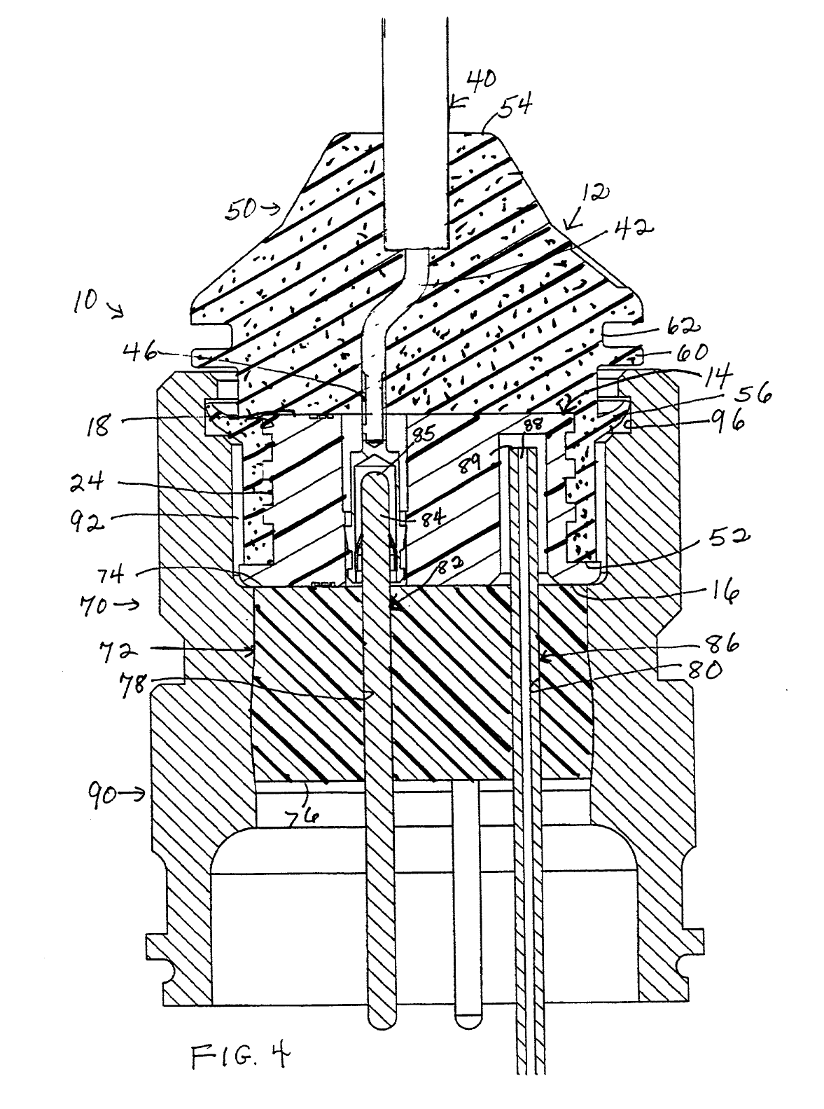

Connector 70 includes a dielectric housing 72 having a mating face 74, assembly face 76, and a plurality of terminals 82 disposed in respective terminal receiving passageways 78, only one of which is shown. Terminals 82 have a first connecting portion 84 shown as a pin for mating with socket terminal 30 of connector 12 and a second connecting portion, not shown. In the embodiment shown, housing 72 further includes a tube 86 having a passageway 88 extending therethrough that is adapted to receive a probe for testing the device to which connector 70 is secured. Dielectric housing 72 is disposed in a connector receiving passageway of metallic shell 90 having a shroud 94 extending forwardly therefrom and defining a connector receiving or mating cavity 92. Mating cavity 92 includes an undercut defining a retention notch 96 extending into the inner sidewalls of shell 90. As can be seen in FIGS. 3 and 4, the leading ends 85, 89 of terminal 82 and tube 86, respectively extend into mating cavity 92. The leading end 89 of tube 86 extends beyond the leading end 85 of pin terminal 84, thus serving an alignment function for the connectors 12 and 70. Upon mating connectors 12 and 70, end 89 is received in aperture 22 of housing 14 to assure the connectors are oriented properly prior to mating of the terminals 30, 82.

FIGS. 3 and 4 illustrate the connectors 12 and 70 when they are partially mated and fully mated respectively. As previously described, the connectors are initially aligned by the tube 80 before the terminals 84 enter the respective terminal receiving passageways. FIG. 3 illustrates connector 12 just as the sealing and retention protrusion 56 engages the leading end of shell 90. As more force is applied to continue the mating process the resilient elastomeric sealing and retention protrusion 56 is compressed and pressed against the inner walls of shroud 94, thus wiping the inner surface of shroud 90. Upon reaching the fully mated position, as shown in FIG. 4, protrusion 56 resiles partially outwardly and deforms as it enters retention notch 96 to retain and seal connector 12 in the mated position. As can be seen in FIG. 3, the depth of retention notch 96 is less than the full width of protrusion 56 such that protrusion 56 remains under partial compression thereby sealing connector 12 within shroud 94. The geometry of the protrusion 56 enables the connector 12 to more easily engage the connector 70 while allowing air trapped between the connectors 12, 70 during mating to escape, thereby providing a better connection between the two connectors. The geometry also provides improved retention capability compared to a conventional O-ring.

Specifically, the relatively flat upper surface and angled lower surface (as seen from the orientation of FIGS. 3 and 4) enables the rib 56 to easily bend when the connector 12 is inserted into the connector 70 and when the connector 12 is fully seated in the connector 70 the rib 56 sits in the receiving cavity 96 in a manner that resist disengagement, as seen in FIG. 4. As can be seen in these Figures, sealing and retention protrusion or rib 56 eliminates both the need for O-rings and latches.

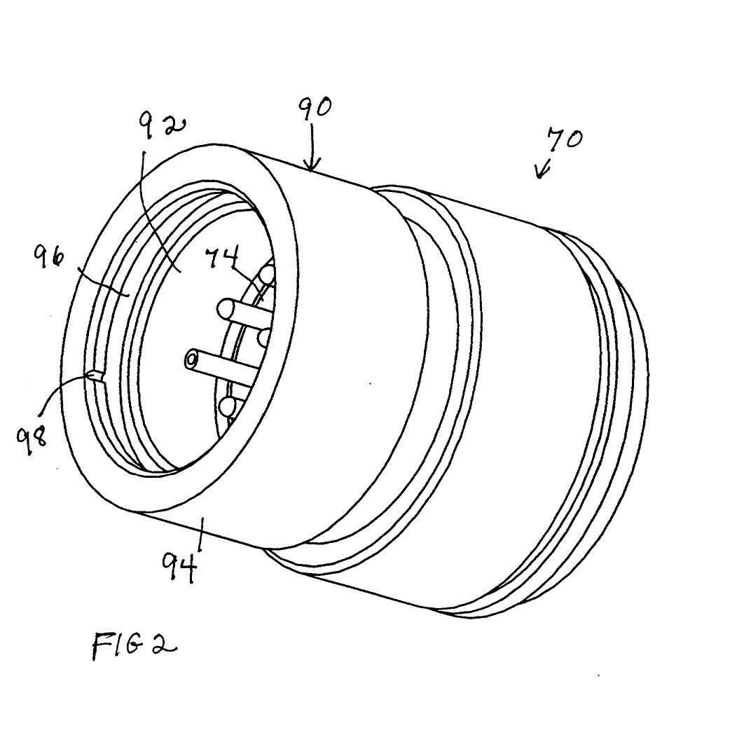

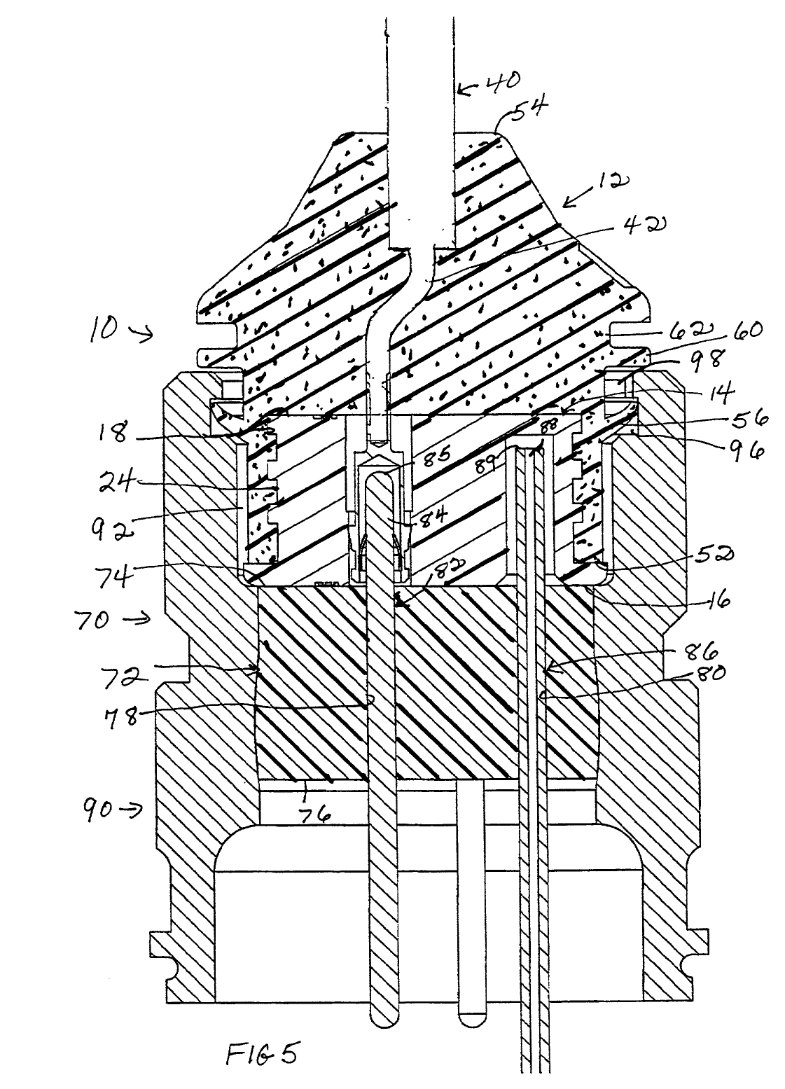

As best seen in FIGS. 2 and 5, shroud 94 may also include an air release passageway 98 that permits air to escape as the connectors 12 and 70 are mated. As connector 12 is inserted into shroud 94, air can escape through passageway 98 prior to protrusion 56 entering retention notch 96 at which time it resiles outwardly to a seal against the inner surface of shroud 94, as shown seen in FIG. 5.

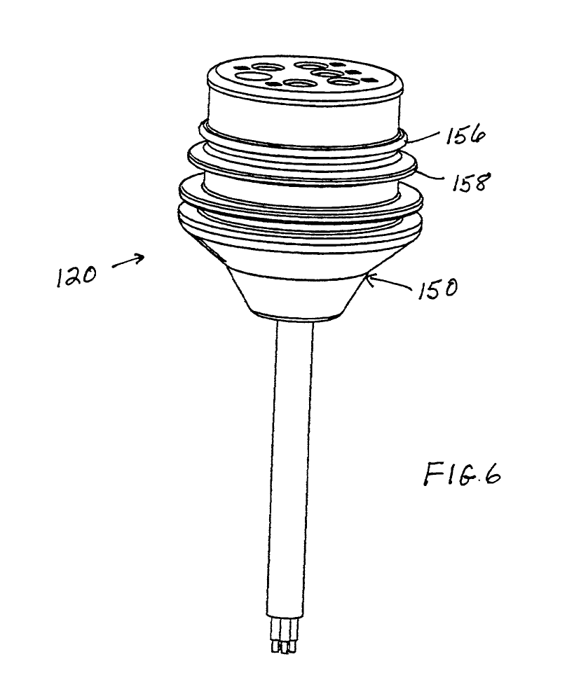

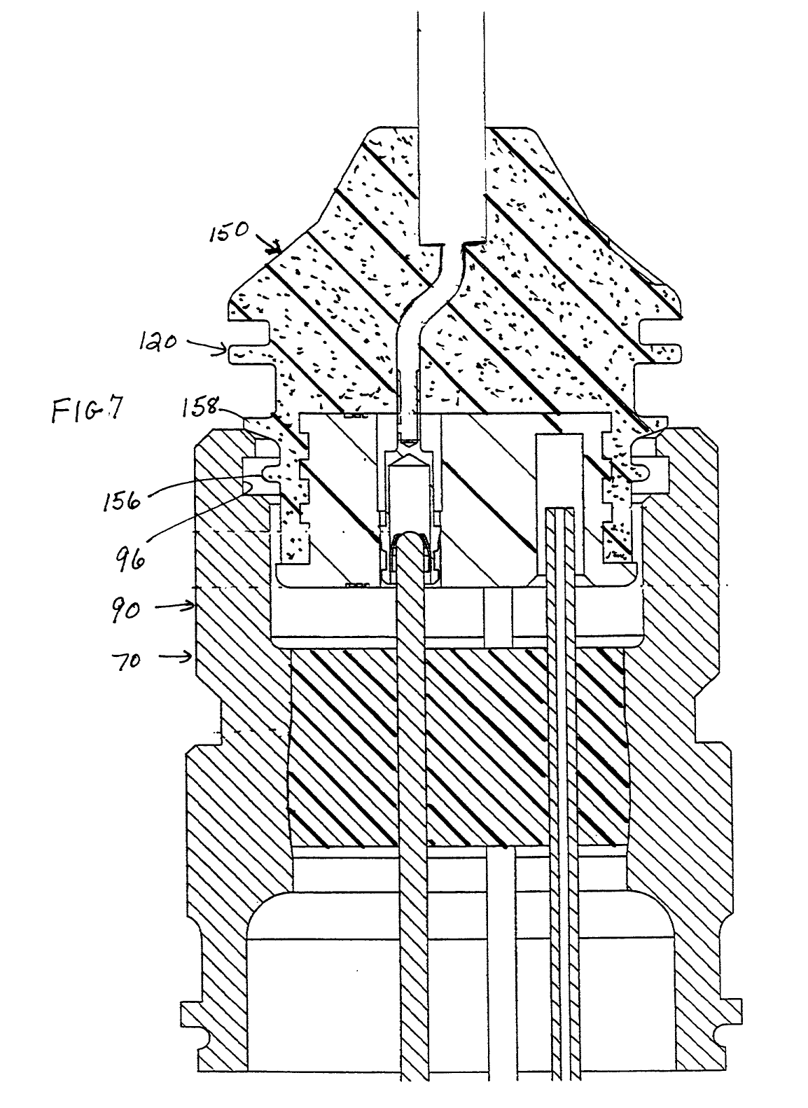

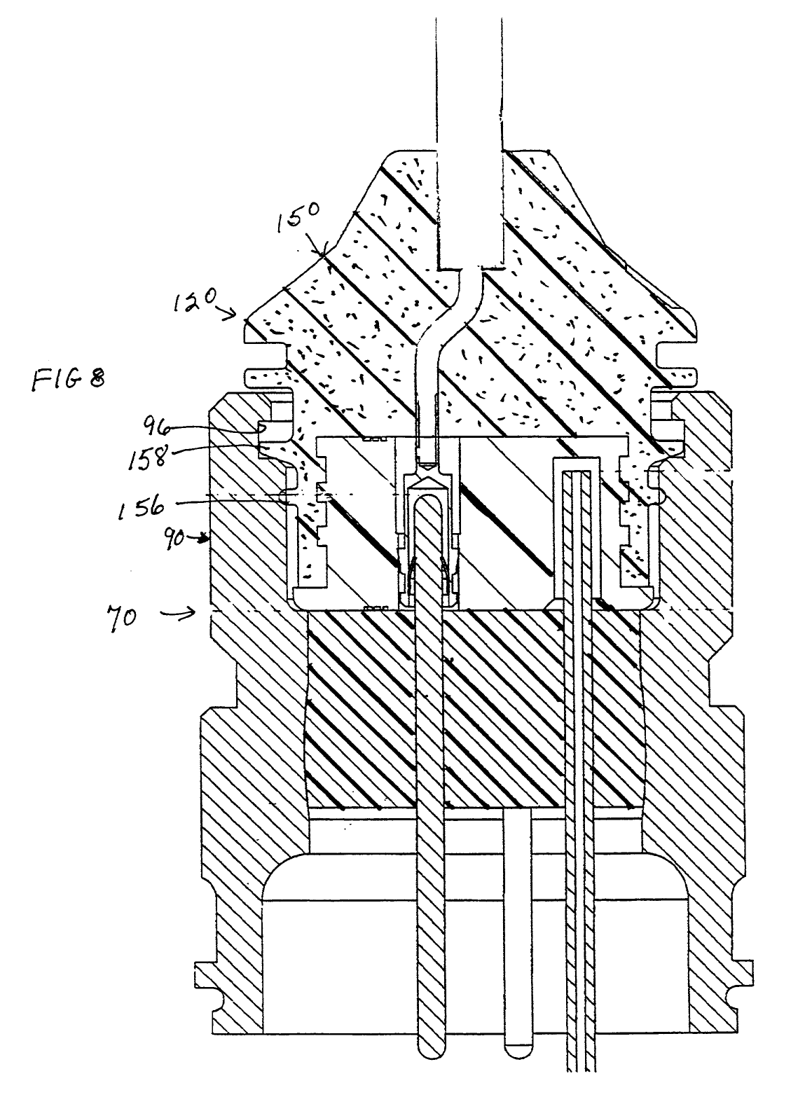

FIGS. 6 through 8 illustrate another embodiment 120 of the connector of the invention. Connector 120 is substantially identical to connector 12 except that the peripheral surface of outer housing 150 includes a sealing protrusion or rib 156 and a separate retention protrusion or rib 158. The mating sequence is illustrated in FIGS. 7 and 8, which show that sealing protrusion 156 is forward of retention protrusion 158. In this embodiment the compression of the sealing protrusion 156 is closer to the mating interface of the two connectors 120 and 70. It is to be understood that a plurality of sealing protrusions 156 may also be used. It is also to be understood that the retention protrusion need only extend around a portion of the peripheral surface of the outer housing. FIG. 7 shows the retention protrusion 158 in position within retention notch 96 of shroud 90 and sealing protrusion 156 in engagement with the inner shroud wall thus sealing the connectors.

Inner housing 14 is made from standard housing materials, as known in the art. The outer housing 50 is molded from an elastomeric material having sufficient flexibility and compressibility to permit the sealing protrusions to function as described above. Suitable materials include, for example, thermoplastic elastomers that are compatable with the material used for the inner housing. In assembling the connector 12 striped ends 46 of the conductors 42 are terminated to respective terminals 30 and disposed in terminal receiving passageways 20 in inner housing 14 to form a subassembly. The outer elastomeric housing 50 is overmolded on the subassembly to form the connector 12.

The present invention provides a sealed connector assembly that minimizes the number of components thereby reducing the number of steps in the assembly process and is cost effective to manufacture. The retention features do not increase the exterior dimensions of the mating interface of the connectors of the assembly thereby permitting the connectors to be spaced relatively close together if required. Additionally, the invention assures that air can escape as the connectors are being mated to assure a viable seal. When the connector is terminated to a cable, the outer housing functions as a strain relief for the cable, thereby eliminating the need for a separate component to provide the strain relief.

It is thought that the sealed connector and connector assembly of the present invention and many of the attendant advantages will be understood from the foregoing description. It is apparent that various changes may be made in the form, construction, and arrangement of parts thereof without departing from the spirit or scope of the invention, or sacrificing all of its material advantages.

We claim:

1. An electrical connector comprising:
an inner housing having at least one terminal disposed therein; and
an elastomeric outer housing disposed around the inner housing and having at least one sealing member that extends outwardly around a peripheral surface of the outer housing and is dimensioned to be sealingly received within a connector receiving cavity of a complementary connector upon being mated thereto and at least one retention member that extends outwardly from the peripheral surface and dimensioned to cooperate with a complementary surface within the cavity to retain the mated connectors together;
whereby, upon mating with the complementary connector, the outer housing provides both sealing and retention for the mated connectors.

2. The electrical connector of claim 1 wherein a single protrusion extends around the peripheral surface of the outer housing and defines both the sealing member and the retention member.

3. The electrical connector of claim 1 wherein the at least one sealing member and the at least one retention member are spaced from one another.

4. The electrical connector of claim 3 wherein the sealing member is forward of the retention member such that upon mating the connectors, the sealing member is closer to the complementary connector than the retention member.

5. The electrical connector of claim 3 wherein the retention member extends around the peripheral surface of the outer housing.

6. The electrical connector of claim 1 wherein a first end of the at least one terminal is terminated to a conductor of a cable and wherein the outer housing is disposed around a portion of the conductor thereby providing strain relief for the cable.

7. A connector assembly comprising:
an electrical connector having an inner housing with at least one terminal disposed therein, and an elastomeric outer housing disposed around the inner housing, the outer housing having at least one sealing member that extends outwardly around a peripheral surface thereof and at least one retention member that extends outwardly from the peripheral surface; and
a complementary mating connector having a shroud extending from a mating face defining a connector receiving cavity, an inner surface of the shroud including a retention notch that cooperates with the retention member,
whereby upon mating the connectors, the sealing member is sealingly received within the connector receiving cavity of the complementary mating connector and the retention member is received in the retention notch.

8. The connector assembly of claim 7 wherein the shroud further includes an air release passageway such that upon mating the connectors, air can escape from the connector receiving cavity prior to the sealing member being sealed against the inner surface of the cavity.

9. The electrical connector of claim 7 wherein a single protrusion extends around the peripheral surface of the outer housing defining both the sealing member and the retention member.

10. The electrical connector of claim 7 wherein the at least one sealing member and the at least one retention member are spaced from one another.

11. The electrical connector of claim 10 wherein the sealing member is forward of the retention member such that upon mating the connectors, the sealing member is closer to the complementary connector than the retention member.

12. The electrical connector of claim 10 wherein the retention member extends around the peripheral surface of the outer housing.

13. The electrical connector of claim 7 wherein a first end of the at least one terminal is terminated to a conductor of a cable and wherein the outer housing is disposed around a portion of the conductor thereby providing strain relief for the cable.

14. The electrical connector of claim 8 wherein a single protrusion extends around the peripheral surface of the outer housing defining both the sealing member and the retention member.

15. The electrical connector of claim 8 wherein the at least one sealing member and the at least one retention member are spaced from one another.

16. The electrical connector of claim 15 wherein the sealing member is forward of the retention member such that upon mating the connectors, the sealing member is closer to the complementary connector than the retention member.

17. The electrical connector of claim 15 wherein the retention member extends around the peripheral surface of the outer housing.

18. The electrical connector of claim 8 wherein a first end of the at least one terminal is terminated to a conductor of a cable and wherein the outer housing is disposed around a portion of the conductor thereby providing strain relief for the cable.
